(19) United States
(12) Patent Application Publication
(10) Pub. No.: US 2025/0150974 A1
(43) Pub. Date: May 8, 2025

(54) UPLINK POWER CONTROL FOR MULTIPLE TRANSMIT-RECEIVE POINTS

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Tao LUO, San Diego, CA (US)

(21) Appl. No.: 18/837,743

(22) PCT Filed: Apr. 11, 2022
(86) PCT No.: PCT/CN2022/086086

§ 371 Date: Aug. 12, 2024

(51) Int. Cl. H04W 52/14; H04W 52/36

(52) U.S. Cl. CPC H04W 52/146; H04W 52/367

(57) ABSTRACT

Various aspects of the present disclosure generally relate to wireless communication. In some aspects, a user equipment (UE) may receive, from a network entity associated with a first transmit-receive point (TRP) and a second TRP, an uplink power control configuration that configures a first set of uplink power control parameters associated with the first TRP and a second set of uplink power control parameters associated with the second TRP. The UE may transmit, to the first TRP, a first uplink transmission based at least in part on the first set of uplink power control parameters associated with the first TRP. The UE may transmit, to the second TRP, a second uplink transmission based at least in part on the second set of uplink power control parameters associated with the second TRP. Numerous other aspects are described.

### FIELD OF THE DISCLOSURE

Aspects of the present disclosure generally relate to wireless communication and to techniques and apparatuses for uplink power control for multiple transmit-receive points (TRPs).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: receive, from one of a first transmit-receive point (TRP) or a second TRP, an uplink power control configuration that configures a first set of uplink power control parameters associated with the first TRP and a second set of uplink power control parameters associated with the second TRP; transmit, to the first TRP, a first uplink transmission based at least in part on the first set of uplink power control parameters associated with the first TRP; and transmit, to the second TRP, a second uplink transmission based at least in part on the second set of uplink power control parameters associated with the second TRP.

In some implementations, an apparatus for wireless communication at a first TRP includes a memory and one or more processors, coupled to the memory, configured to: transmit, to a UE, an uplink power control configuration that configures a first set of uplink power control parameters associated with the first TRP and a second set of uplink power control parameters associated with a second TRP; and receive, from the UE, a first uplink transmission based at least in part on the first set of uplink power control parameters associated with the first TRP.

In some implementations, a method of wireless communication performed by a UE includes receiving, from a network entity associated with a first TRP and a second TRP, an uplink power control configuration that configures a first set of uplink power control parameters associated with the first TRP and a second set of uplink power control parameters associated with the second TRP; transmitting, to the first TRP, a first uplink transmission based at least in part on the first set of uplink power control parameters associated with the first TRP; and transmitting, to the second TRP, a second uplink transmission based at least in part on the second set of uplink power control parameters associated with the second TRP.

In some implementations, a method of wireless communication performed by a first TRP includes transmitting, to a UE, an uplink power control configuration that configures a first set of uplink power control parameters associated with the first TRP and a second set of uplink power control parameters associated with a second TRP; and receiving, from the UE, a first uplink transmission based at least in part on the first set of uplink power control parameters associated with the first TRP.

In some implementations, a non-transitory computer-readable medium storing a set of instructions for wireless communication includes one or more instructions that, when executed by one or more processors of a UE, cause the UE to: receive, from a network entity associated with a first TRP and a second TRP, an uplink power control configuration that configures a first set of uplink power control parameters associated with the first TRP and a second set of uplink power control parameters associated with the second TRP; transmit, to the first TRP, a first uplink transmission based at least in part on the first set of uplink power control parameters associated with the first TRP; and transmit, to the second TRP, a second uplink transmission based at least in part on the second set of uplink power control parameters associated with the second TRP.

In some implementations, a non-transitory computer-readable medium storing a set of instructions for wireless communication includes one or more instructions that, when executed by one or more processors of a first TRP, cause the first TRP to: transmit, to a UE, an uplink power control configuration that configures a first set of uplink power control parameters associated with the first TRP and a second set of uplink power control parameters associated with a second TRP; and receive, from the UE, a first uplink transmission based at least in part on the first set of uplink power control parameters associated with the first TRP.

In some implementations, an apparatus for wireless communication includes means for receiving, from a network entity associated with a first TRP and a second TRP, an uplink power control configuration that configures a first set of uplink power control parameters associated with the first TRP and a second set of uplink power control parameters associated with the second TRP; means for transmitting, to the first TRP, a first uplink transmission based at least in part on the first set of uplink power control parameters associated with the first TRP; and means for transmitting, to the second TRP, a second uplink transmission based at least in part on the second set of uplink power control parameters associated with the second TRP.

In some implementations, a first apparatus for wireless communication includes means for transmitting, to a UE, an uplink power control configuration that configures a first set of uplink power control parameters associated with the first apparatus and a second set of uplink power control parameters associated with a second apparatus; and means for receiving, from the UE, a first uplink transmission based at least in part on the first set of uplink power control parameters associated with the first apparatus.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIGS. 4-6 are diagrams illustrating examples of multiple transmit-receive point (TRP) operations, in accordance with the present disclosure.

FIG. 7 is a diagram illustrating an example associated with uplink power control for multiple TRPs, in accordance with the present disclosure.

FIGS. 8-9 are diagrams illustrating example processes associated with uplink power control for multiple TRPs, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

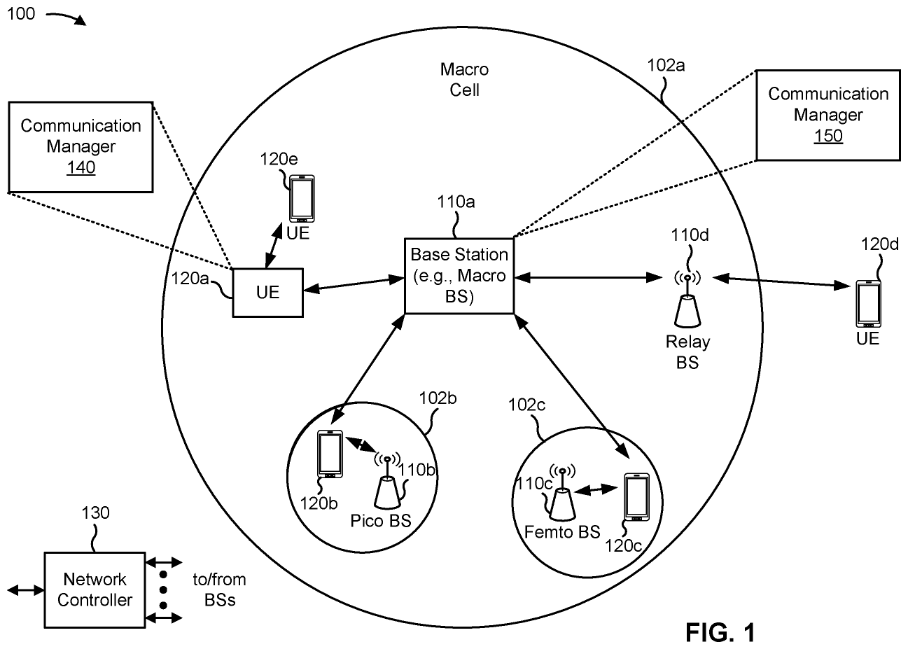

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmit-receive point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network entity associated with a first TRP and a second TRP, an uplink power control configuration that configures a first set of uplink power control parameters associated with the first TRP and a second set of uplink power control parameters associated with the second TRP; transmit, to the first TRP, a first uplink transmission based at least in part on the first set of uplink power control parameters associated with the first TRP; and transmit, to the second TRP, a second uplink transmission based at least in part on the second set of uplink power control parameters associated with the second TRP. Additionally, or alternatively, the communication manager 140 may perform one or more other operations described herein.

In some aspects, a first TRP (e.g., base station 110) may include a communication manager 150. As described in more detail elsewhere herein, the communication manager 150 may transmit, to a UE, an uplink power control configuration that configures a first set of uplink power control parameters associated with the first TRP and a second set of uplink power control parameters associated with a second TRP; and receive, from the UE, a first uplink transmission based at least in part on the first set of uplink power control parameters associated with the first TRP. Additionally, or alternatively, the communication manager 150 may perform one or more other operations described herein.

As indicated above, FIG. 1 is provided as an example. Other examples may differ from what is described with regard to FIG. 1.

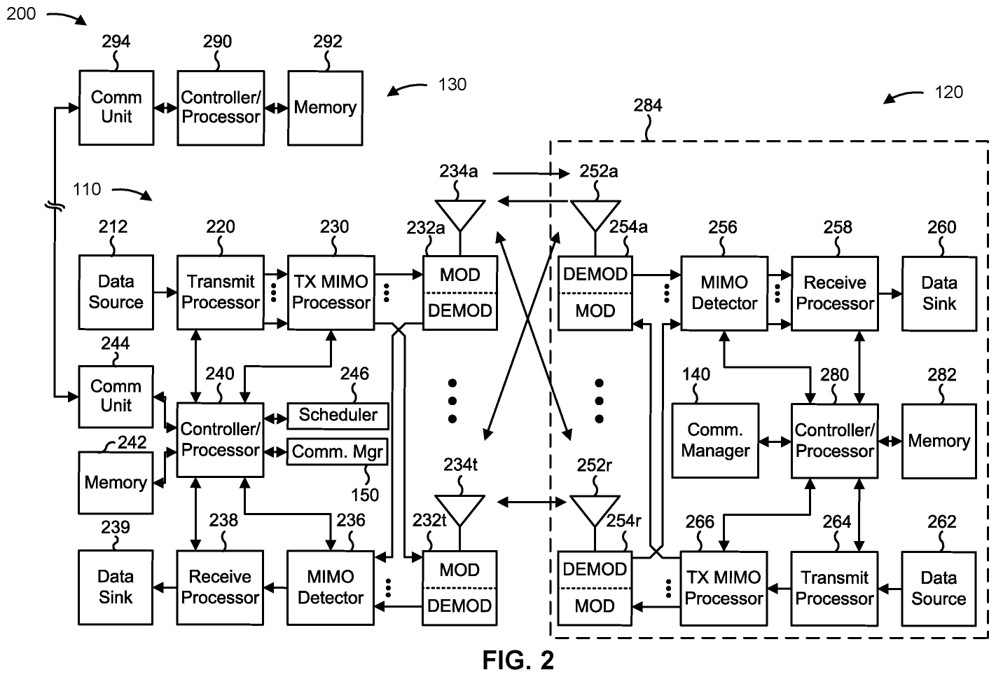

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

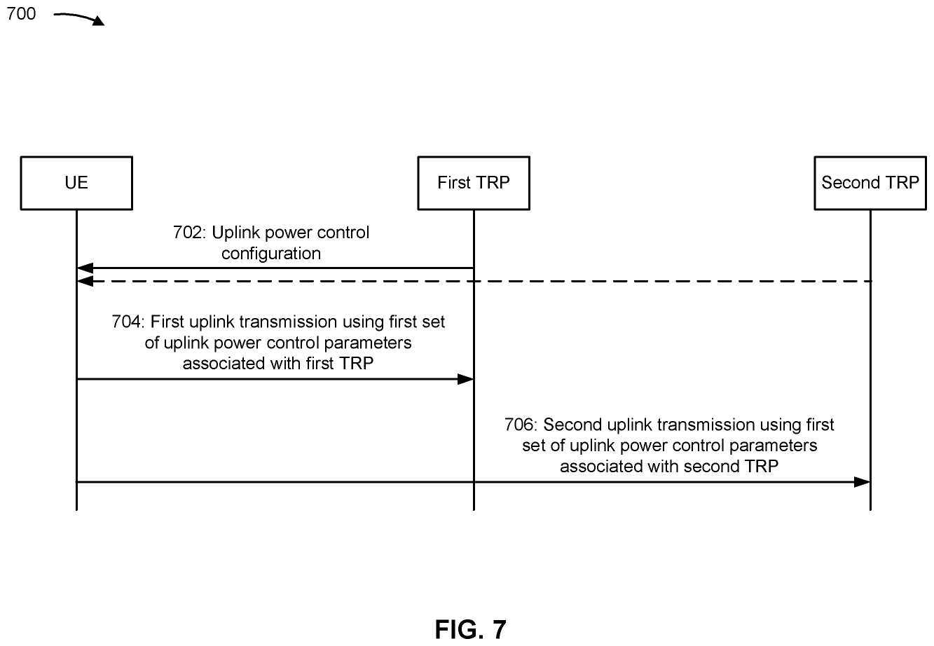

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-11).

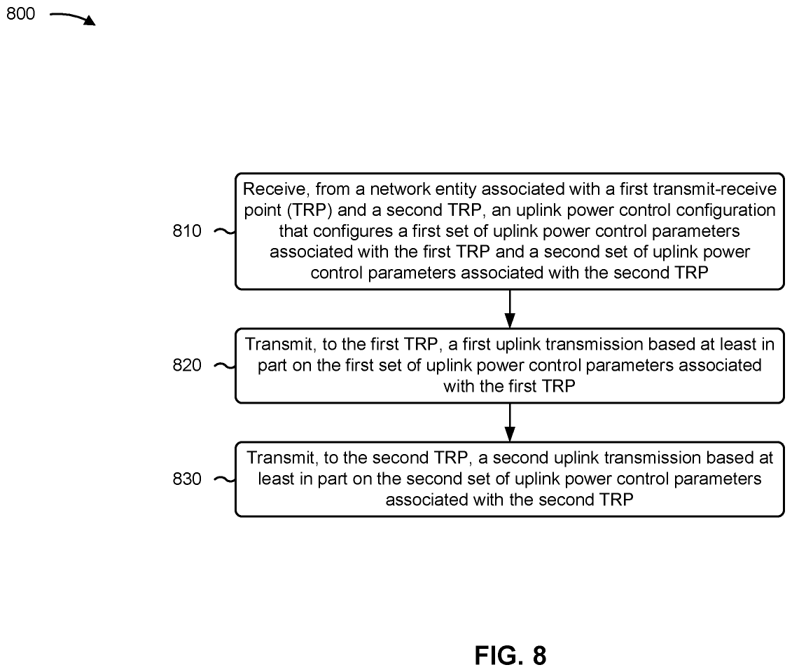

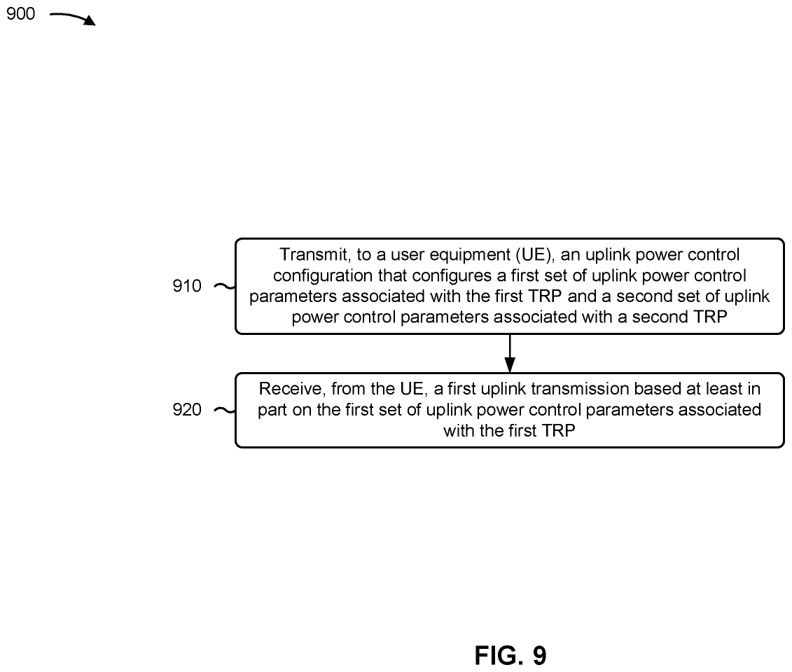

The controller/processor 240 of the base station 110, the controller/processor 280 of the UE 120, and/or any other component(s) of FIG. 2 may perform one or more techniques associated with uplink power control for multiple TRPs, as described in more detail elsewhere herein. In some aspects, the first TRP described herein is the base station 110, is included in the base station 110, or includes one or more components of the base station 110 shown in FIG. 2. In some aspects, the second TRP described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a network entity associated with a first TRP and a second TRP, an uplink power control configuration that configures a first set of uplink power control parameters associated with the first TRP and a second set of uplink power control parameters associated with the second TRP; means for transmitting, to the first TRP, a first uplink transmission based at least in part on the first set of uplink power control parameters associated with the first TRP; and/or means for transmitting, to the second TRP, a second uplink transmission based at least in part on the second set of uplink power control parameters associated with the second TRP. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a first TRP (e.g., base station 110) includes means for transmitting, to a UE, an uplink power control configuration that configures a first set of uplink power control parameters associated with the first TRP and a second set of uplink power control parameters associated with a second TRP; and/or means for receiving, from the UE, a first uplink transmission based at least in part on the first set of uplink power control parameters associated with the first TRP. The means for the first TRP to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

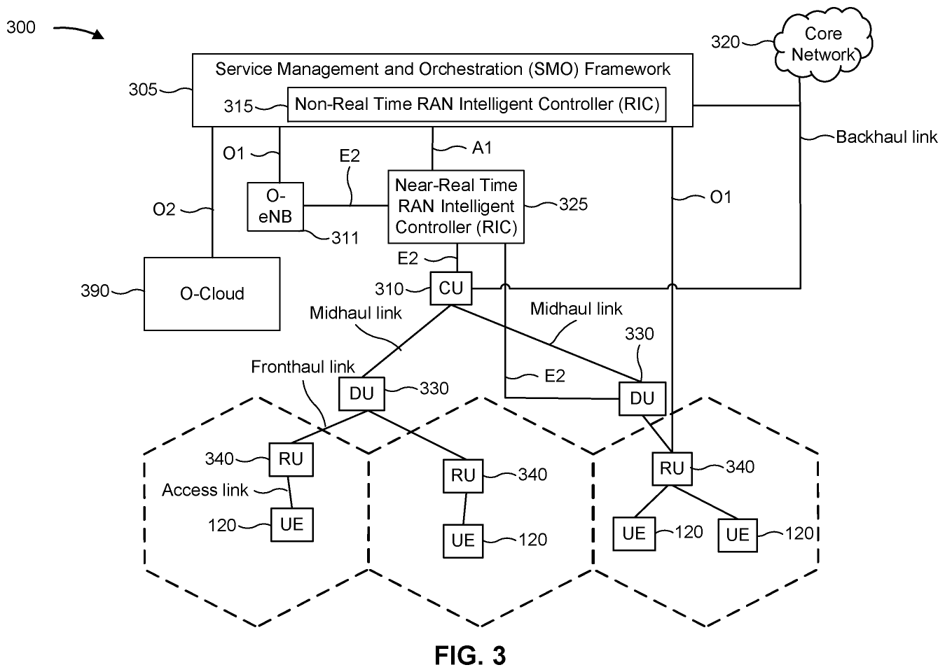

FIG. 3 is a diagram illustrating an example 300 of a disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

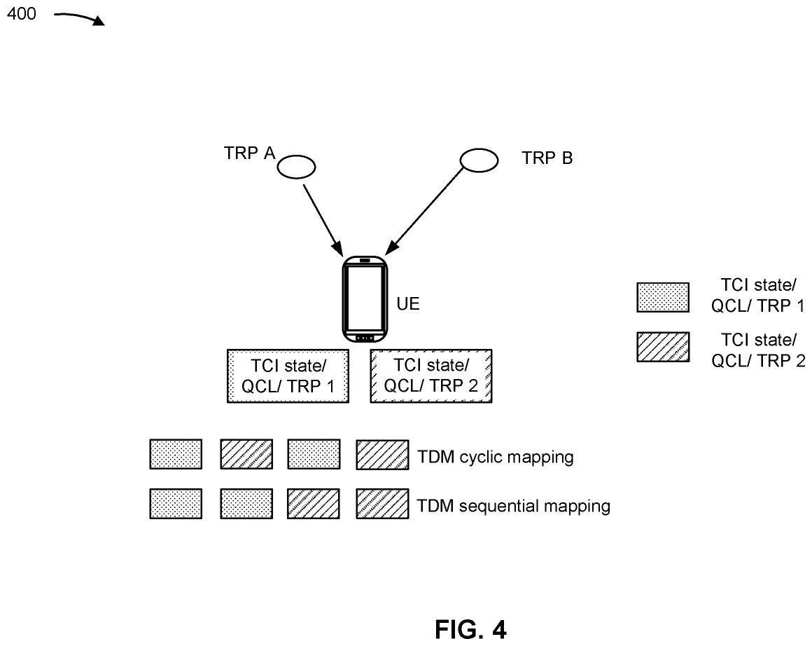

FIG. 4 is a diagram illustrating an example 400 of multi-TRP operations, in accordance with the present disclosure.

As shown in FIG. 4, in a multi-TRP operation, a UE may communicate with a first TRP (TRP A) and a second TRP (TRP B). The first TRP may be associated with a first transmission configuration indicator (TCI) state or a first quasi co-location (QCL). The second TRP may be associated with a second TCI state or a second QCL. The UE may perform uplink transmissions to the first TRP and the second TRP using time division multiplexing (TDM). The UE may perform uplink transmissions to the first TRP and the second TRP using TDM cyclic mapping, in which the UE may alternative between performing uplink transmissions to the first TRP and the second TRP. For example, the UE may perform a first uplink transmission to the first TRP, a second uplink transmission to the second TRP, a third uplink transmission to the first TRP, and a fourth uplink transmission to the second TRP. The UE may perform uplink transmissions to the first TRP and the second TRP using TDM sequential mapping, in which the UE may first perform a set of uplink transmissions to the first TRP and then perform a set of uplink transmissions to the second TRP. For example, the UE may perform a first uplink transmission and a second uplink transmission to the first TRP, and then the UE may perform a third uplink transmission and a fourth uplink transmission to the second TRP.

As indicated above, FIG. 4 is provided as an example. Other examples may differ from what is described with regard to FIG. 4.

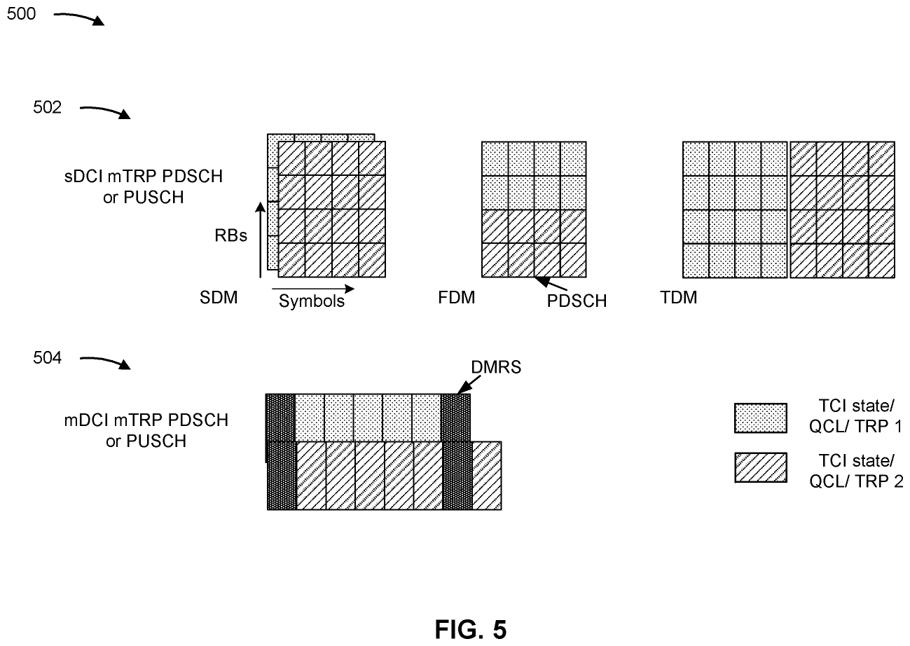

FIG. 5 is a diagram illustrating an example 500 of multi-TRP operations, in accordance with the present disclosure.

As shown by reference number 502, in a multi-TRP operation, a UE may support a single downlink control information (DCI) multi-TRP physical downlink shared channel (PDSCH) transmission or physical uplink shared channel (PUSCH) transmission. In a first example, a first transmission associated with a first TRP (e.g., first TCI state or first QCL) may be spatial division multiplexed (SDM) with a second transmission associated with a second TRP (e.g., second TCI state or second QCL). The first transmission and the second transmission may be associated with different spatial layers, but may overlap in time and/or frequency. In a second example, the first transmission may be frequency division multiplexed (FDM) with the second transmission. The first transmission and the second transmission may be simultaneous transmissions and may overlap in time but not in frequency. In a third example, the first transmission may be TDM with the second transmission. The first transmission and the second transmission may be non-simultaneous transmissions. The first transmission and the second transmission may overlap in frequency but not in time.

As shown by reference number 504, in the multi-TRP operation, a UE may support a multiple DCI (multi-DCI) multiple TRP (multi-TRP) PDSCH transmission or PUSCH transmission. A first transmission associated with a first TRP may be frequency division multiplexed with a second transmission associated with a second TRP. The first transmission and the second transmission may be associated with separate DMRSs.

As indicated above, FIG. 5 is provided as an example. Other examples may differ from what is described with regard to FIG. 5.

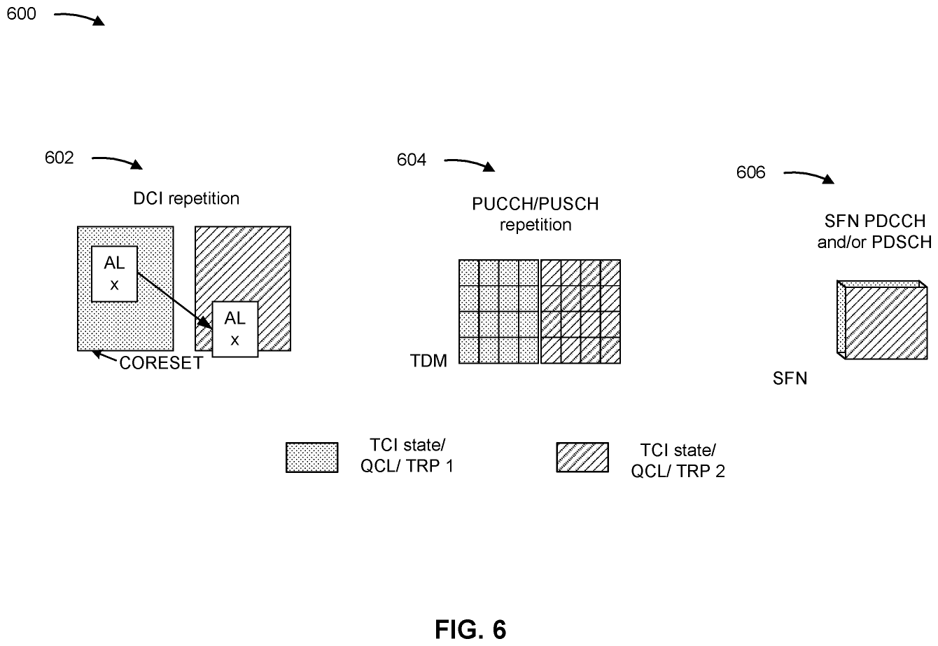

FIG. 6 is a diagram illustrating an example 600 of multi-TRP operations, in accordance with the present disclosure.

As shown by reference number 602, in a multi-TRP operation, a UE may support a DCI repetition. The UE may communicate with a first TRP and a second TRP, where the first TRP may be associated with a first control resource set (CORESET) and/or an aggregation level (AL), and the second TRP may be associated with a second CORESET and/or the AL. As shown by reference number 604, in the multi-TRP operation, the UE may support a physical uplink control channel (PUCCH) or PUSCH repetition, which may be based at least in part on TDM. As shown by reference number 606, in the multi-TRP operation, the UE may support a single-frequency network (SFN) physical downlink control channel (PDCCH) transmission and/or PDSCH transmission, which may be associated with same time/frequency resources (or same layers) but different beams.

As indicated above, FIG. 6 is provided as an example. Other examples may differ from what is described with regard to FIG. 6.

Uplink power control may determine a transmit power for a PUSCH transmissions. A UE may perform a PUSCH transmission on an active uplink bandwidth part (BWP) b of carrier f of serving cell c using a parameter set configuration with index j and a PUSCH power control adjustment state with index l. The UE may determine a PUSCH transmit power P_{PUSCH,b,f,c}(i, j, q_{d}, l) in a PUSCH transmission occasion i as:

$${P}_{PUSCH , b , f , c} ( i , j , {q}_{d} , l ) = min \{ \begin{matrix}{P}_{CMAX , f , c} ( i ) , \\ \begin{matrix}{P}_{0 \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + \\ {Δ}_{TF , b , f , c} ( i ) + {f}_{b , f , c} ( i , l )\end{matrix}\end{matrix} \} .$$

With respect to the PUSCH transmit power P_{PUSCH,b,f,c}(i, j, q_{d}, l) (in dB), P_{CMAX,f,c}(i) may represent a configured maximum uplink transmit power (or configured maximum output power) after backoff due, P_{0_PUSCH,b,f,c}(j) may represent a P0 value for controlling a received power level, M_{RB,b,f,c}^{PUSCH}(i) may represent a bandwidth of a PUSCH resource assignment in terms of a quantity of resource blocks for the PUSCH transmission occasion i, α_{b,f,c}(j) may represent an alpha value for partial pathloss (PL) compensation, PL_{p,f,c}(q_{d}) may represent a pathloss value based at least in part on a measured downlink reference signal with index q_{d}, Δ_{TF,b,f,c}(i) may depend on a resource allocation and an MCS of the PUSCH, and f_{p,f,c}(i, l) may represent a close loop power control based at least in part on transmit power control (TPC) commands with a closed loop index l. Thus, P_{0_PUSCH, b,f,c}(j), M_{RB,b,f,c}(i), α_{p,f,c}(j), PL_{b,f,c}(q_{d}), Δ_{TF,b,f,c}(i) and f_{b,f,c}(i, l) may be parameters used to determine the PUSCH transmit power.

One problem is that the past uplink power control mechanism does not consider simultaneous uplink transmissions. “Simultaneous uplink transmissions” may be two or more uplink transmissions that at least partially overlap in time. In a multi-TRP operation, in which a UE communicates with both a first TRP and a second TRP, simultaneous uplink transmissions may be supported by the UE. The simultaneous uplink transmissions may include simultaneous PUSCH and PUSCH transmissions to the first TRP and the second TRP, respectively. The simultaneous uplink transmissions may include simultaneous PUCCH and PUCCH transmissions to the first TRP and the second TRP, respectively. In the past uplink power control mechanism, for a PUSCH/PUCCH occasion, only an uplink transmission for a single TRP is considered. In the past uplink power control mechanism, a PUSCH power is only associated with a single pathloss value (PL_{p,f,c}(q_{d})) and a single closed-loop index (l), whereas a simultaneous PUSCH transmission to two TRPs is expected to have two separate pathloss values and two separate closed-loop indices.

In various aspects of techniques and apparatuses described herein, a UE may receive, from a first TRP and a second TRP, an uplink power control configuration. The uplink power configuration may configure a first set of uplink power control parameters associated with the first TRP and a second set of uplink power control parameters associated with the second TRP. A past uplink power control mechanism may be modified to consider two components corresponding to two different TRPs for a same uplink transmission (e.g., a same PUSCH/PUCCH transmission), which may result in the first set of uplink power control parameters and the second set of uplink power control parameters. The UE may transmit, to the first TRP, a first uplink transmission based at least in part on the first set of uplink power control parameters associated with the first TRP. The UE may transmit, to the second TRP, a second uplink transmission based at least in part on a second set of uplink power control parameters associated with the second TRP. The first uplink transmission and the second uplink transmission may be simultaneous uplink transmissions. As a result, the UE may be able to apply uplink power control to simultaneous uplink transmissions to both the first TRP and the second TRP.

FIG. 7 is a diagram illustrating an example 700 associated with uplink power control for multiple TRPs, in accordance with the present disclosure. As shown in FIG. 7, example 700 includes communication between a UE (e.g., UE 120), a first TRP (e.g., base station 110a), and a second TRP (e.g., base station 110b). In some aspects, the UE, the first TRP, and the second TRP may be included in a wireless network, such as wireless network 100. In some aspects, in a multi-TRP operation, the UE may communicate with the first TRP and the second TRP.

As shown by reference number 702, the UE may receive, from the first TRP and/or the second TRP, an uplink power control configuration. The uplink power control configuration may configure a first set of uplink power control parameters associated with the first TRP. The uplink power control configuration may configure a second set of uplink power control parameters associated with the second TRP. The uplink power control configuration may be for simultaneous uplink transmissions by the UE to the first TRP and the second TRP, respectively. The simultaneous uplink transmissions may be simultaneous PUSCH transmissions, simultaneous PUCCH transmissions, or simultaneous PUSCH and PUCCH transmissions. The uplink power control configuration may define a power control for the simultaneous uplink transmissions.

In some aspects, the first set of uplink power control parameters, for the first TRP, may include values of P_{CMAX,f,c}⁰(i), P_{0PUSCH,b,f,c}⁰(j), M_{RB,b,f,c}^{0,PUSCH}(i), α_{b,f,c}⁰(j), PL_{b,f,c}⁰(q_{d}), Δ_{TF,b,f,c}⁰(i), and f_{p,f,c}⁰(i, l). In this case, k is equal to 0, which may indicate the first TRP. The second set of uplink power control parameters, for the second TRP, may include values of P_{CMAX,f,c}¹(i), P_{0PUSCH,b,f,c}¹(j), M_{RB,b,f,c}^{1,PUSCH}(i), α_{b,f,c}¹(j), PL_{b,f,c}¹(q_{d}), Δ_{TF,b,f,c}¹(i), and f_{b,f,c}¹(i, l). In this case, k is equal to 1, which may indicate the second TRP.

In some aspects, the first set of uplink power control parameters may be associated with a first k value that indicates the first TRP. The second set of uplink power control parameters may be associated with a second k value that indicates the second TRP. The first k value or the second k value may be a TRP identifier (ID), a TCI state group ID, a TPC ID, a power amplifier ID, a pathloss reference signal ID, a closed-loop index, a CORESET pool index, a sounding reference signal (SRS) resource set ID, a DMRS port group ID, a resource block allocation set ID, or a physical cell ID (PCI). Further, the first set of uplink power control parameters may include a first configured maximum uplink transmit power, and the second set of uplink power control parameters may include a second configured maximum uplink transmit power.

As shown by reference number 704, the UE may transmit, to the first TRP, a first uplink transmission based at least in part on the first set of uplink power control parameters associated with the first TRP, as indicated by the uplink power control configuration. The first uplink transmission may be a PUSCH transmission or a PUCCH transmission. The UE may apply an uplink power control for the first uplink transmission based at least in part on the first set of uplink power control parameters.

As shown by reference number 706, the UE may transmit, to the second TRP, a second uplink transmission based at least in part on a second set of uplink power control parameters associated with the second TRP, as indicated by the uplink power control configuration. The second uplink transmission may be a PUSCH transmission or a PUCCH transmission. The first uplink transmission and the second uplink transmission may be simultaneous uplink transmissions. In other words, the first uplink transmission may at least partially overlap in time with the second uplink transmission. The UE may apply an uplink power control for the second uplink transmission based at least in part on the second set of uplink power control parameters.

In some aspects, when the first uplink transmission and the second uplink transmission are associated with different antenna panels (e.g., separate power amplifiers), the UE may apply the uplink power control separately for the first uplink transmission and the second uplink transmission in accordance with:

$${P}_{PUSCH , b , f , c}^{k} ( i , j , {q}_{d} , l ) = min \{ \begin{matrix}{P}_{CMAX , f , c}^{k} ( i ) \\ \begin{matrix}{P}_{{O}_{PUSCH} , b , f , c}^{k} ( j ) + 10 {log}_{10} ( {2}^{μ} \cdot {M}_{RB , b , f , c}^{k , PUSCH} ( i ) ) + {α}_{b , f , c}^{k} ( j ) \cdot {PL}_{b , f , c}^{k} ( {q}_{d} ) + \\ {Δ}_{TF , b , f , c}^{k} ( i ) + {f}_{b , f , c}^{k} ( i , l )\end{matrix}\end{matrix}$$

(in dBm), where k is equal to 0 for the first TRP and k is equal to 1 for the second TRP. In this case, the UE may apply the uplink power control for the first uplink transmission and the uplink power control for the second uplink transmission on a per-TRP basis. In other words, the uplink power control associated with the first uplink transmission to the first TRP may be independent from the uplink power control associated with the second uplink transmission to the second TRP.

In some aspects, for simultaneous PUSCH or PUCCH transmissions, the uplink power control may consider two components corresponding to the two TRPs, respectively. The two components may be associated with the first uplink transmission and the second uplink transmission. When the two components of an uplink signal for the two TRPs are transmitted with the separate power amplifiers (e.g., from different antenna panels in FR2), the UE may apply the uplink power control (e.g., P_{PUSCH,b,f,c}^{k}(i, j, q_{d}, l)) to each per-TRP component independently. The k value may be the TRP ID, the TCI state group ID, the TPC ID, the power amplifier ID, the pathloss reference signal ID, the closed-loop index, the CORESET pool index, the SRS resource set ID, the DMRS port group ID, the resource block allocation set ID, or the PCI, which may identify the first TRP or the second TRP. In some aspects, each factor of the uplink power control (e.g., P_{CMAX,f,c}^{k}(i), P_{0PUSCH,b,f,c}^{k}(j), M_{RB,b,f,c}^{k,PUSCH}(i), α_{b,f,c}^{k}(j), PL_{b,f,c}^{k}(q_{d}), Δ_{TF,b,f,c}^{k}(i), and f_{b,f,c}^{k}(i, l)) may be associated with its own k value, which may be 0 or 1. In some aspects, the per-TRP component may be further capped by the per-TRP configured maximum uplink transmit power P_{CMAX,f,c}^{k}.

In some aspects, when the first uplink transmission and the second uplink transmission are associated with a same antenna panel (e.g., a common power amplifier), the UE may apply a total uplink power control for the first uplink transmission and the second uplink transmission in accordance with:

$${P}_{PUSCH , b , f , c} ( i , j , {q}_{d} , l ) = min \{ \begin{matrix}{P}_{CMAX , f , c} ( i ) \\ {\sum }_{k = 0}^{K - 1} [ \begin{matrix}{P}_{{O}_{PUSCH} , b , f , c}^{k} ( j ) + 10 {log}_{10} ( {2}^{μ} \cdot {M}_{RB , b , f , c}^{k , PUSCH} ( i ) ) + \\ {α}_{b , f , c}^{k} ( j ) \cdot {PL}_{b , f , c}^{k} ( {q}_{d} ) + {Δ}_{TF , b , f , c}^{k} ( i ) + {f}_{b , f , c}^{k} ( i , l )\end{matrix} ]\end{matrix}$$

(in dBm), where k is equal to 0 for the first TRP and k is equal to 1 for the second TRP. In this case, the total uplink power control may be associated with both the first uplink transmission and the second uplink transmission. The total uplink power may be a linear sum of transmit powers for two TRPs in the operation of [·], and the total uplink power may be expressed as dBm. In other words, the total power P_{PUSCH,b,f,c}(i, j, q_{d}, l) may be a linear sum by converting two transmit power components in [.] operation for different TRPs from the dBm values to the linear values first, and may be further converted back to the dBm value, and may be capped by the cell-level total configured uplink transmit power P_{CMAX,f,c}(i). The total uplink power control may be based at least in part on a summation (or sum) of the first set of uplink power control parameters and the second set of uplink power control parameters. In this case, the total uplink power control may not be on a per-TRP basis due to the same antenna panel being used. Rather, the total uplink power control may be based at least in part on a combination of the first uplink transmission and the second uplink transmission. In some aspects, the total uplink power control may be based at least in part on a cell-level configured maximum uplink transmit power.

In some aspects, when the two components of the uplink signal for the two TRPs are transmitted with a common power amplifier (e.g., from a same antenna in FR2), the UE may perform the uplink power control (e.g., P_{PUSCH,b,f,c}^{k}(i, j, q_{d}, l)) by including both per-TRP components. A sum power may be capped by the cell-level configured maximum uplink transmit power (P_{CMAX,f,c}), as opposed to a TRP-specific total configured maximum uplink transmit power. In other words, a summation of the two per-TRP Tx power P_{PUSCH,b,f,c}^{k}(i, j, q_{d}, l) may also be further capped by the cell-level configured maximum uplink transmit power.

In some aspects, the first set of uplink power control parameters and the second set of uplink power control parameters may each be associated with a k value that corresponds to a TRP ID. The k value may be mapped to a TCI state or a joint TCI state. The k value associated with the TRP ID may be represented by one of the TCI state IDs used for indicating uplink beams for the simultaneous uplink transmissions. For example, k=0, 1 may be mapped to the two uplink or joint TCI states with lower and higher TCI state IDs, respectively. As another example, k=0, 1 may be mapped to the two uplink or joint TCI states with lower and higher mapping order indexes, respectively, when mapped to a same TCI codepoint as indicated in a TCI activation MAC control element (MAC-CE).

In some aspects, a TCI-based TRP identification may not introduce a new parameter. The TCI-based TRP identification may be applicable to single-DCI and multi-DCI multi-TRP operations. The TCI-based TRP identification may be applicable to both SDM-based and FDM-based simultaneous uplink transmissions. The TCI-based TRP identification may allow both TRPs to share the same uplink power control parameters. In some aspects, TRP identification may be based at least in part on the TRP ID, the TCI state group ID, the TPC ID, the power amplifier ID, the pathloss reference signal ID, the closed-loop index, the CORESET pool index, the SRS resource set ID, the DMRS port group ID, the resource block allocation set ID, or the PCI.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with uplink power control for multiple TRPs.

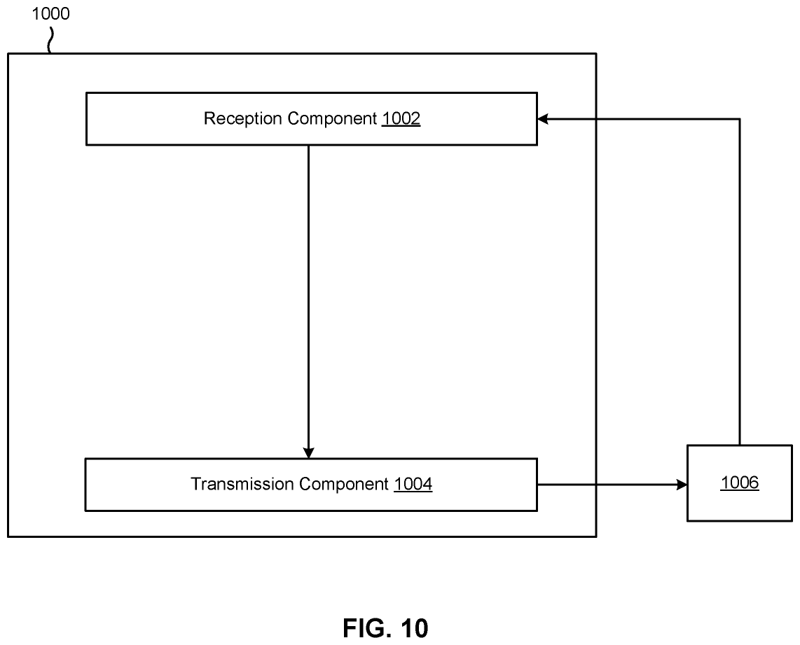

As shown in FIG. 8, in some aspects, process 800 may include receiving, from a network entity associated with a first TRP and a second TRP, an uplink power control configuration that configures a first set of uplink power control parameters associated with the first TRP and a second set of uplink power control parameters associated with the second TRP (block 810). For example, the UE (e.g., using reception component 1002, depicted in FIG. 10) may receive, from a network entity associated with a first TRP and a second TRP, an uplink power control configuration that configures a first set of uplink power control parameters associated with the first TRP and a second set of uplink power control parameters associated with the second TRP, as described above.

As further shown in FIG. 8, in some aspects, process 800 may include transmitting, to the first TRP, a first uplink transmission based at least in part on the first set of uplink power control parameters associated with the first TRP (block 820). For example, the UE (e.g., using transmission component 1004, depicted in FIG. 10) may transmit, to the first TRP, a first uplink transmission based at least in part on the first set of uplink power control parameters associated with the first TRP, as described above.

As further shown in FIG. 8, in some aspects, process 800 may include transmitting, to the second TRP, a second uplink transmission based at least in part on the second set of uplink power control parameters associated with the second TRP (block 830). For example, the UE (e.g., using transmission component 1004, depicted in FIG. 10) may transmit, to the second TRP, a second uplink transmission based at least in part on the second set of uplink power control parameters associated with the second TRP, as described above.

Process 800 may include additional aspects, such as any single aspect or any combination of aspects described below and/or in connection with one or more other processes described elsewhere herein.

In a first aspect, the first uplink transmission overlaps in time with the second uplink transmission.

In a second aspect, alone or in combination with the first aspect, an uplink power control associated with the first uplink transmission and an uplink power control associated with the second uplink transmission are on a per-TRP basis.

In a third aspect, alone or in combination with one or more of the first and second aspects, the first uplink transmission and the second uplink transmission are associated with different antenna panels.

In a fourth aspect, alone or in combination with one or more of the first through third aspects, the first set of uplink power control parameters are associated with a first value that indicates the first TRP, and the second set of uplink power control parameters are associated with a second value that indicates the second TRP.

In a fifth aspect, alone or in combination with one or more of the first through fourth aspects, the first value or the second value is one of a TRP ID, a TCI state group ID, a TPC ID, a power amplifier ID, a pathloss reference signal ID, a closed-loop index, a CORESET pool index, an SRS resource set ID, a DMRS port group ID, a resource block allocation set ID, or a PCI.

In a sixth aspect, alone or in combination with one or more of the first through fifth aspects, the first set of uplink power control parameters includes a configured maximum uplink transmit power, and the second set of uplink power control parameters includes a second UE configured maximum uplink transmit power.

In a seventh aspect, alone or in combination with one or more of the first through sixth aspects, the first uplink transmission and the second uplink transmission are associated with a same antenna panel.

In an eighth aspect, alone or in combination with one or more of the first through seventh aspects, an uplink power control is associated with both the first uplink transmission and the second uplink transmission.

In a ninth aspect, alone or in combination with one or more of the first through eighth aspects, the uplink power control is based at least in part on a sum of the first set of uplink power control parameters and the second set of uplink power control parameters, or wherein the uplink power control is based at least in part on a cell-level configured maximum uplink transmit power.

In a tenth aspect, alone or in combination with one or more of the first through ninth aspects, the first set of uplink power control parameters and the second set of uplink power control parameters are each associated with a value that corresponds to a TRP identifier, wherein the value is mapped to an uplink TCI state or a joint TCI state.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a first TRP, in accordance with the present disclosure. Example process 900 is an example where the first TRP (e.g., base station 110) performs operations associated with uplink power control for multiple TRPs.

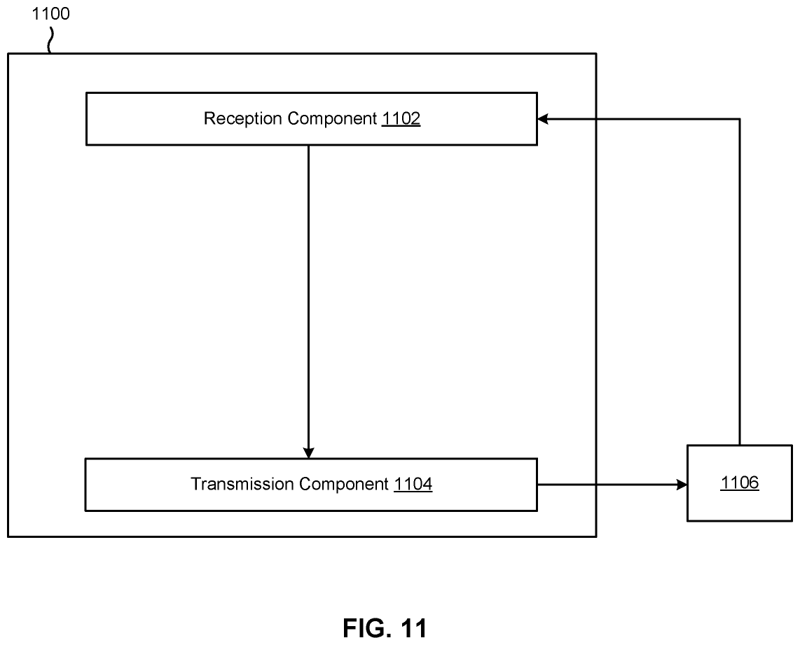

As shown in FIG. 9, in some aspects, process 900 may include transmitting, to a UE, an uplink power control configuration that configures a first set of uplink power control parameters associated with the first TRP and a second set of uplink power control parameters associated with a second TRP (block 910). For example, the first TRP (e.g., using transmission component 1104, depicted in FIG. 11) may transmit, to a UE, an uplink power control configuration that configures a first set of uplink power control parameters associated with the first TRP and a second set of uplink power control parameters associated with a second TRP, as described above.

As further shown in FIG. 9, in some aspects, process 900 may include receiving, from the UE, a first uplink transmission based at least in part on the first set of uplink power control parameters associated with the first TRP (block 920). For example, the first TRP (e.g., using reception component 1102, depicted in FIG. 11) may receive, from the UE, a first uplink transmission based at least in part on the first set of uplink power control parameters associated with the first TRP, as described above.

Process 900 may include additional aspects, such as any single aspect or any combination of aspects described below and/or in connection with one or more other processes described elsewhere herein.

In a first aspect, the first uplink transmission overlaps in time with the second uplink transmission, and the second uplink transmission is based at least in part on the second set of uplink power control parameters associated with the second TRP.

In a second aspect, alone or in combination with the first aspect, process 900 includes the first set of uplink power control parameters are associated with a first value that indicates the first TRP, and the second set of uplink power control parameters are associated with a second value that indicates the second TRP.

In a third aspect, alone or in combination with one or more of the first and second aspects, the first value or the second value is one of a TRP ID, a TCI state group ID, a TPC ID, a power amplifier ID, a pathloss reference signal ID, a closed-loop index, a CORESET pool index, an SRS resource set ID, a DMRS port group ID, a resource block allocation set ID, or a PCI.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004.

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive, from a network entity associated with a first TRP and a second TRP, an uplink power control configuration that configures a first set of uplink power control parameters associated with the first TRP and a second set of uplink power control parameters associated with the second TRP. The transmission component 1004 may transmit, to the first TRP, a first uplink transmission based at least in part on the first set of uplink power control parameters associated with the first TRP. The transmission component 1004 may transmit, to the second TRP, a second uplink transmission based at least in part on the second set of uplink power control parameters associated with the second TRP.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a first TRP, or a first TRP may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104.

In some aspects, the apparatus 1100 may be configured to perform one or more operations described herein in connection with FIG. 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the first TRP described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the first TRP described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the first TRP described in connection with FIG. 2. In some aspects, the transmission component 1104 may be co-located with the reception component 1102 in a transceiver.

The transmission component 1104 may transmit, to a UE, an uplink power control configuration that configures a first set of uplink power control parameters associated with the first TRP and a second set of uplink power control parameters associated with a second TRP. The reception component 1102 may receive, from the UE, a first uplink transmission based at least in part on the first set of uplink power control parameters associated with the first TRP.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving, from a network entity associated with a first transmit-receive point (TRP) and a second TRP, an uplink power control configuration that configures a first set of uplink power control parameters associated with the first TRP and a second set of uplink power control parameters associated with the second TRP; transmitting, to the first TRP, a first uplink transmission based at least in part on the first set of uplink power control parameters associated with the first TRP; and transmitting, to the second TRP, a second uplink transmission based at least in part on the second set of uplink power control parameters associated with the second TRP.

Aspect 2: The method of Aspect 1, wherein the first uplink transmission overlaps in time with the second uplink transmission.

Aspect 3: The method of any of Aspects 1 through 2, wherein an uplink power control associated with the first uplink transmission and an uplink power control associated with the second uplink transmission are on a per-TRP basis.

Aspect 4: The method of any of Aspects 1 through 3, wherein the first uplink transmission and the second uplink transmission are associated with different antenna panels.

Aspect 5: The method of any of Aspects 1 through 4, wherein: the first set of uplink power control parameters are associated with a first value that indicates the first TRP; and the second set of uplink power control parameters are associated with a second value that indicates the second TRP.

Aspect 6: The method of Aspect 5, wherein the first value or the second value is one of: a TRP identifier (ID), a transmission configuration indicator state group ID, a transmit power control ID, a power amplifier ID, a pathloss reference signal ID, a closed-loop index, a control resource set pool index, a sounding reference signal resource set ID, a demodulation reference signal port group ID, a resource block allocation set ID, or a physical cell ID.

Aspect 7: The method of any of Aspects 1 through 6, wherein the first set of uplink power control parameters includes a configured maximum uplink transmit power, and the second set of uplink power control parameters includes a second UE configured maximum uplink transmit power.

Aspect 8: The method of any of Aspects 1 through 7, wherein the first uplink transmission and the second uplink transmission are associated with a same antenna panel.

Aspect 9: The method of any of Aspects 1 through 8, wherein an uplink power control is associated with both the first uplink transmission and the second uplink transmission.

Aspect 10: The method of Aspect 9, wherein the uplink power control is based at least in part on a sum of the first set of uplink power control parameters and the second set of uplink power control parameters, or wherein the uplink power control is based at least in part on a cell-level configured maximum uplink transmit power.

Aspect 11: The method of any of Aspects 1 through 10, wherein the first set of uplink power control parameters and the second set of uplink power control parameters are each associated with a value that corresponds to a TRP identifier, wherein the value is mapped to an uplink transmission configuration state (TCI) state or a joint TCI state.

Aspect 12: A method of wireless communication performed by a first transmit-receive point (TRP), comprising: transmitting, to a user equipment (UE), an uplink power control configuration that configures a first set of uplink power control parameters associated with the first TRP and a second set of uplink power control parameters associated with a second TRP; and receiving, from the UE, a first uplink transmission based at least in part on the first set of uplink power control parameters associated with the first TRP.

Aspect 13: The method of Aspect 12, wherein the first uplink transmission overlaps in time with a second uplink transmission, and wherein the second uplink transmission is based at least in part on the second set of uplink power control parameters associated with the second TRP.

Aspect 14: The method of Aspect 13, wherein: the first set of uplink power control parameters are associated with a first value that indicates the first TRP; and the second set of uplink power control parameters are associated with a second value that indicates the second TRP.

Aspect 15: The method of any of Aspects 12 through 14, wherein the first value or the second value is one of: a TRP identifier (ID), a transmission configuration indicator state group ID, a transmit power control ID, a power amplifier ID, a pathloss reference signal ID, a closed-loop index, a control resource set pool index, a sounding reference signal resource set ID, a demodulation reference signal port group ID, a resource block allocation set ID, or a physical cell ID.

Aspect 16: An apparatus for wireless communication at a device, comprising a processor; memory coupled with the processor; and instructions stored in the memory and executable by the processor to cause the apparatus to perform the method of one or more of Aspects 1-11.

Aspect 17: A device for wireless communication, comprising a memory and one or more processors coupled to the memory, the one or more processors configured to perform the method of one or more of Aspects 1-11.

Aspect 18: An apparatus for wireless communication, comprising at least one means for performing the method of one or more of Aspects 1-11.

Aspect 19: A non-transitory computer-readable medium storing code for wireless communication, the code comprising instructions executable by a processor to perform the method of one or more of Aspects 1-11.

Aspect 20: A non-transitory computer-readable medium storing a set of instructions for wireless communication, the set of instructions comprising one or more instructions that, when executed by one or more processors of a device, cause the device to perform the method of one or more of Aspects 1-11.

Aspect 21: An apparatus for wireless communication at a device, comprising a processor; memory coupled with the processor; and instructions stored in the memory and executable by the processor to cause the apparatus to perform the method of one or more of Aspects 12-15.

Aspect 22: A device for wireless communication, comprising a memory and one or more processors coupled to the memory, the one or more processors configured to perform the method of one or more of Aspects 12-15.

Aspect 23: An apparatus for wireless communication, comprising at least one means for performing the method of one or more of Aspects 12-15.

Aspect 24: A non-transitory computer-readable medium storing code for wireless communication, the code comprising instructions executable by a processor to perform the method of one or more of Aspects 12-15.

Aspect 25: A non-transitory computer-readable medium storing a set of instructions for wireless communication, the set of instructions comprising one or more instructions that, when executed by one or more processors of a device, cause the device to perform the method of one or more of Aspects 12-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from one of a first transmit-receive point (TRP) or a second TRP, an uplink power control configuration that configures a first set of uplink power control parameters associated with the first TRP and a second set of uplink power control parameters associated with the second TRP;
transmit, to the first TRP, a first uplink transmission based at least in part on the first set of uplink power control parameters associated with the first TRP; and
transmit, to the second TRP, a second uplink transmission based at least in part on the second set of uplink power control parameters associated with the second TRP.

2. The apparatus of claim 1, wherein the first uplink transmission overlaps in time with the second uplink transmission.

3. The apparatus of claim 1, wherein an uplink power control associated with the first uplink transmission and an uplink power control associated with the second uplink transmission are on a per-TRP basis.

4. The apparatus of claim 1, wherein the first uplink transmission and the second uplink transmission are associated with different antenna panels.

5. The apparatus of claim 1, wherein:
the first set of uplink power control parameters are associated with a first value that indicates the first TRP; and
the second set of uplink power control parameters are associated with a second value that indicates the second TRP.

6. The apparatus of claim 5, wherein the first value or the second value is one of: a TRP identifier (ID), a transmission configuration indicator state group ID, a transmit power control ID, a power amplifier ID, a pathloss reference signal ID, a closed-loop index, a control resource set pool index, a sounding reference signal resource set ID, a demodulation reference signal port group ID, a resource block allocation set ID, or a physical cell ID.

7. The apparatus of claim 1, wherein the first set of uplink power control parameters includes a configured maximum uplink transmit power, and the second set of uplink power control parameters includes a second UE configured maximum uplink transmit power.

8. The apparatus of claim 1, wherein the first uplink transmission and the second uplink transmission are associated with a same antenna panel.

9. The apparatus of claim 1, wherein an uplink power control is associated with both the first uplink transmission and the second uplink transmission.

10. The apparatus of claim 9, wherein the uplink power control is based at least in part on a sum of the first set of uplink power control parameters and the second set of uplink power control parameters, or wherein the uplink power control is based at least in part on a cell-level configured maximum uplink transmit power.

11. The apparatus of claim 1, wherein the first set of uplink power control parameters and the second set of uplink power control parameters are each associated with a value that corresponds to a TRP identifier, wherein the value is mapped to an uplink transmission configuration indicator (TCI) state or a joint TCI state.

12. An apparatus for wireless communication at a first transmit-receive point (TRP), comprising:
a memory; and
one or more processors, coupled to the memory, configured to:
transmit, to a user equipment (UE), an uplink power control configuration that configures a first set of uplink power control parameters associated with the first TRP and a second set of uplink power control parameters associated with a second TRP; and
receive, from the UE, a first uplink transmission based at least in part on the first set of uplink power control parameters associated with the first TRP.

13. The apparatus of claim 12, wherein the first uplink transmission overlaps in time with a second uplink transmission, and wherein the second uplink transmission is based at least in part on the second set of uplink power control parameters associated with the second TRP.

14. The apparatus of claim 13, wherein:
the first set of uplink power control parameters are associated with a first value that indicates the first TRP; and
the second set of uplink power control parameters are associated with a second value that indicates the second TRP.

15. The apparatus of claim 14, wherein the first value or the second value is one of:
a TRP identifier (ID), a transmission configuration indicator state group ID, a transmit power control ID, a power amplifier ID, a pathloss reference signal ID, a closed-loop index, a control resource set pool index, a sounding reference signal resource set ID, a demodulation reference signal port group ID, a resource block allocation set ID, or a physical cell ID.

16. A method of wireless communication performed by a user equipment (UE), comprising:
receiving, from a network entity associated with a first transmit-receive point (TRP) and a second TRP, an uplink power control configuration that configures a first set of uplink power control parameters associated with the first TRP and a second set of uplink power control parameters associated with the second TRP;
transmitting, to the first TRP, a first uplink transmission based at least in part on the first set of uplink power control parameters associated with the first TRP; and
transmitting, to the second TRP, a second uplink transmission based at least in part on the second set of uplink power control parameters associated with the second TRP.

17. The method of claim 16, wherein the first uplink transmission overlaps in time with the second uplink transmission.

18. The method of claim 16, wherein an uplink power control associated with the first uplink transmission and an uplink power control associated with the second uplink transmission are on a per-TRP basis.

19. The method of claim 16, wherein the first uplink transmission and the second uplink transmission are associated with different antenna panels.

20. The method of claim 16, wherein:
the first set of uplink power control parameters are associated with a first value that indicates the first TRP; and
the second set of uplink power control parameters are associated with a second value that indicates the second TRP.

21. The method of claim 20, wherein the first value or the second value is one of: a TRP identifier (ID), a transmission configuration indicator state group ID, a transmit power control ID, a power amplifier ID, a pathloss reference signal ID, a closed-loop index, a control resource set pool index, a sounding reference signal resource set ID, a demodulation reference signal port group ID, a resource block allocation set ID, or a physical cell ID.

22. The method of claim 16, wherein the first set of uplink power control parameters includes a configured maximum uplink transmit power, and the second set of uplink power control parameters includes a second UE configured maximum uplink transmit power.

23. The method of claim 16, wherein the first uplink transmission and the second uplink transmission are associated with a same antenna panel.

24. The method of claim 16, wherein an uplink power control is associated with both the first uplink transmission and the second uplink transmission.

25. The method of claim 24, wherein the uplink power control is based at least in part on a sum of the first set of uplink power control parameters and the second set of uplink power control parameters, or wherein the uplink power control is based at least in part on a cell-level configured maximum uplink transmit power.

26. The method of claim 16, wherein the first set of uplink power control parameters and the second set of uplink power control parameters are each associated with a value that corresponds to a TRP identifier, wherein the value is mapped to an uplink transmission configuration indicator (TCI) state or a joint TCI state.

27. A method of wireless communication performed by a first transmit-receive point (TRP), comprising:
transmitting, to a user equipment (UE), an uplink power control configuration that configures a first set of uplink power control parameters associated with the first TRP and a second set of uplink power control parameters associated with a second TRP; and
receiving, from the UE, a first uplink transmission based at least in part on the first set of uplink power control parameters associated with the first TRP.

28. The method of claim 27, wherein the first uplink transmission overlaps in time with a second uplink transmission, and wherein the second uplink transmission is based at least in part on the second set of uplink power control parameters associated with the second TRP.

29. The method of claim 28, wherein:
the first set of uplink power control parameters are associated with a first value that indicates the first TRP; and
the second set of uplink power control parameters are associated with a second value that indicates the second TRP.

30. The method of claim 29, wherein the first value or the second value is one of: a TRP identifier (ID), a transmission configuration indicator state group ID, a transmit power control ID, a power amplifier ID, a pathloss reference signal ID, a closed-loop index, a control resource set pool index, a sounding reference signal resource set ID, a demodulation reference signal port group ID, a resource block allocation set ID, or a physical cell ID.
